(19) United States
(12) Patent Application Publication
(10) Pub. No.: US 2012/0124957 A1
(43) Pub. Date: May 24, 2012

(54) Floating pond rake

(76) Inventor: Thomas Meyers, Wilmington, NC (US)

(21) Appl. No.: 13/373,632

(22) Filed: Nov. 22, 2011

Related U.S. Application Data
(60) Provisional application No. 61/458,486, filed on Nov. 24, 2010.

(51) Int. Cl. A01D 7/00

(52) U.S. Cl. 56/400.01

(57) ABSTRACT

A rake is described that is particularly adapted for removing vegetation and other debris from ponds and other bodies of water. The rake includes a debris collector, an elongated handle having a distal end attached to the debris collector, and a proximal end, and a flotation mechanism that has a raised position and a lowered position, whereby the debris collector is held above the water when the flotation mechanism is in the lowered position and is lowered into the water when the flotation mechanism is moved to its raised position. A preferred flotation mechanism includes a rotatable shaft with opposed ends; parallel connector arms having proximal ends attached to the ends of said rotatable shaft and extending to one side of said shaft, and distal ends; floats attached to the distal ends of said connector arms; and an actuator to rotate said rotatable shaft to raise and lower said floats.

This application claims the benefit of Provisional Application Ser. No. 61/458,486, filed Nov. 24, 2010, which is incorporated herein by reference in its entirety.

### BACKGROUND OF THE INVENTION

(1) Field of the Invention

The present invention relates generally to an improved rake for removing vegetation and other debris from the surface of ponds and other bodies of water, and in particular to a rake having a debris collector that is supported above the water by floats while the rake is moved into position for collection and lowered into the water for collection by raising the level of the floats relative to the debris collector.

(2) Description of the Prior Art

Ponds, both natural and artificial ponds, such as retention ponds, as well as other bodies of water, become overgrown with weeds and other natural vegetation that must be removed in order for the pond to be useable for most purposes. Often, removal is done with power machinery attached to boats. The prior art has also proposed the use of rakes for removal of pond debris and vegetation. Most of these rakes are specifically designed for removal of debris from pond bottoms and have no relevance to the present invention.

Two prior art patents describe rakes specifically designed for removal of debris from pond surfaces. U.S. Pat. No. 5,079,905 to Bergestrom describes a rake that has a rake head with a crossbar filled with a flotation material, and a plurality of downwardly extending tines. The rake head is attached to a rope. The user tosses the rake into the pond beyond the debris that is to be removed, holding onto the rope. The rake head then floats on the surface of the water with the tines extending beneath the water surface so that debris is collected on the tines as the rake is pulled to shore.

U.S. Pat. No. 7,603,836 to Grosjean describes a debris collector comprised of a C-shaped collection screen having a float attached to its top edge and a heavier than water bar attached to its lower edge. A rope is attached to the float. When placed in the water, either by throwing the rake from shore or by attaching the rake behind a boat, the float is at the water's surface with the screen extending beneath the water.

While these prior art rakes may be useful in dragging vegetation and other debris from the pond surface once the rake is in position, there is still a need for a rake that can be more easily placed in the desired position for debris removal, as well as being moveable to other positions when debris is not being collected.

### SUMMARY OF THE INVENTION

The present invention provides a rake that achieves these objectives. Specifically, the present rake is comprised of a debris collector, an elongated handle attached to the debris collector, and adjustable flotation mechanism having a lowered position to hold the debris collector above the surface of the water while the rake is being moved to the desired location, and a raised position in which the debris collector is lowered into the water so that vegetation and other debris will be collected when the rake is pulled toward shore.

More specifically, the rake of the invention is comprised of a debris collector having an upper edge and a lower edge, an elongated handle having a distal end attached to the debris collector and a proximal end to be held by the user, floats adjacent either end of the debris collector, and an actuator for raising and lowering the floats relative to the debris collector.

The debris collector may be of various configurations depending on the type of debris to be collected. For most aquatic vegetation, the debris collector will be comprised of a plurality of aligned, spaced tines having upper ends attached to a reinforcing bar, and lower ends preferably curving rearwardly.

Alternatively, the debris collector can be comprised of a rectangular, curved open-mesh screen having upper and lower edges and opposed side edges. A reinforcing bar may be positioned along the upper edge of the screen. A cover may also extend over the top and sides of the collector, with the screen and covers together completing a debris entrapment chamber. The debris collector is preferably made of aluminum for durability and resistance to the environment.

The elongated handle, preferably made of aluminum tubing, has a distal end attached to the debris collector, preferably to the upper reinforcing bar, and a proximal end. A transverse handgrip may be attached to the handle proximal end to be grasped by the user.

The flotation mechanism is comprised of floats that are positioned at either side of the debris collector. In a preferred embodiment, the flotation mechanism is comprised of a rotatable shaft having parallel connector arms attached transversely at their proximal ends to the ends of the shaft, and axles extending outwardly from the distal ends of the connector arms. The connector arms preferably extend slightly rearwardly from the vertical axis of the debris collector. The floats, which preferably have a circular periphery, i.e., which are wheel-shaped, are rotatably mounted on the axles.

The floats are raised and lowered by an actuator, which, in a preferred embodiment, includes a control bar that has a proximal end fixedly attached to, and extending upwardly from, the rotatable shaft, and a control cable that is attached to the distal end of the control bar and extends to the handle proximal end for gripping by the user.

In operation, the rake with the floats in their lowered position is simply rolled on the floats to the pond edge and then on top of the vegetation until the rake is beyond the vegetation to be removed. The floats are then raised to lower the debris collector into the water. Generally, lowering is accomplished by simply releasing tension on the cable, which results in pivoting of the floats rearwardly due to the weight of the debris collector. The rake is then pulled toward shore collecting the debris. When the shore is reached the user can continue to pull the rake, which rolls onto shore to pull the debris onto the shore.

### BRIEF DESCRIPTION OF THE DRAWINGS

FIG. 1 is a top view of the floating pond rake.

FIG. 2 is a perspective view of the front portion of the floating pond rake.

FIG. 3 is a rear view of the floating pond rake.

FIG. 4 is a front view of the floating pond rake.

FIG. 5 is a side view of the floating pond rake with the floats in their lowered position.

FIG. 6 is a side view of the floating pond rake with the floats in their raised position.

FIG. 7 is a perspective view of the complete floating pond rake.

FIG. 8 is a perspective view of the floating pond rake with an alternative debris collector.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

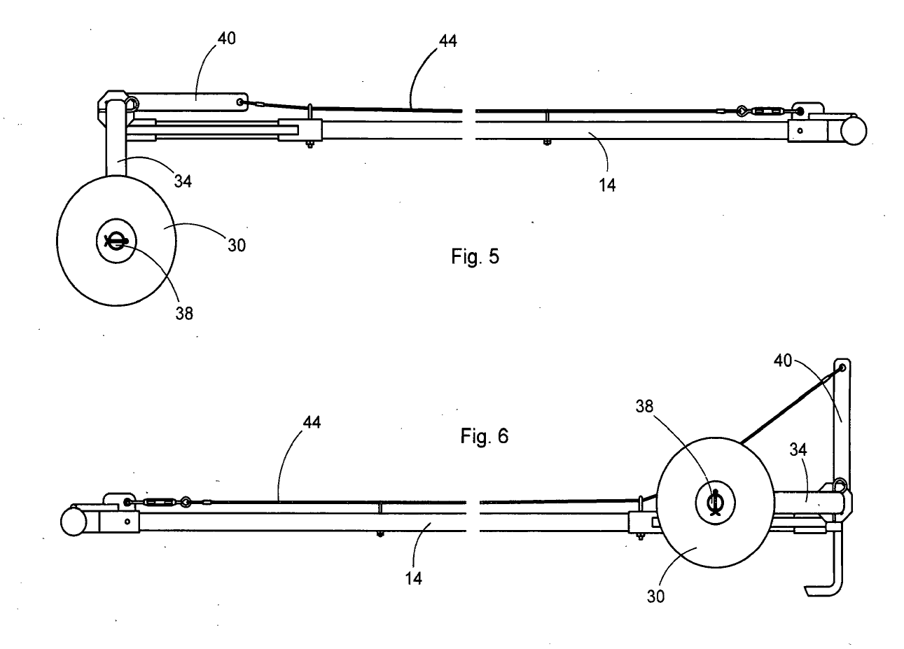

As seen in the drawings, a preferred embodiment of the present pond rake, generally 10, is comprised of a debris collector, generally 12, configured to scoop vegetation and other debris from the pond surface as the rake is pulled toward shore, a handle 14 for use in pulling collector 12, and adjustable flotation mechanism, generally 16, having a lowered position as illustrated in FIG. 5 to hold debris collector 12 above the surface of the water while positioning rake 10, and a raised position as illustrated in FIG. 6 in which debris collector 12 is substantially beneath the water surface. Handle 14 is generally longer than conventional tool handles, often having a length of from about 10 to about 34 feet, since the rake is designed for rolling of debris collector 12 and should be long enough to position debris collector 12 beyond the debris to be collected while standing on shore.

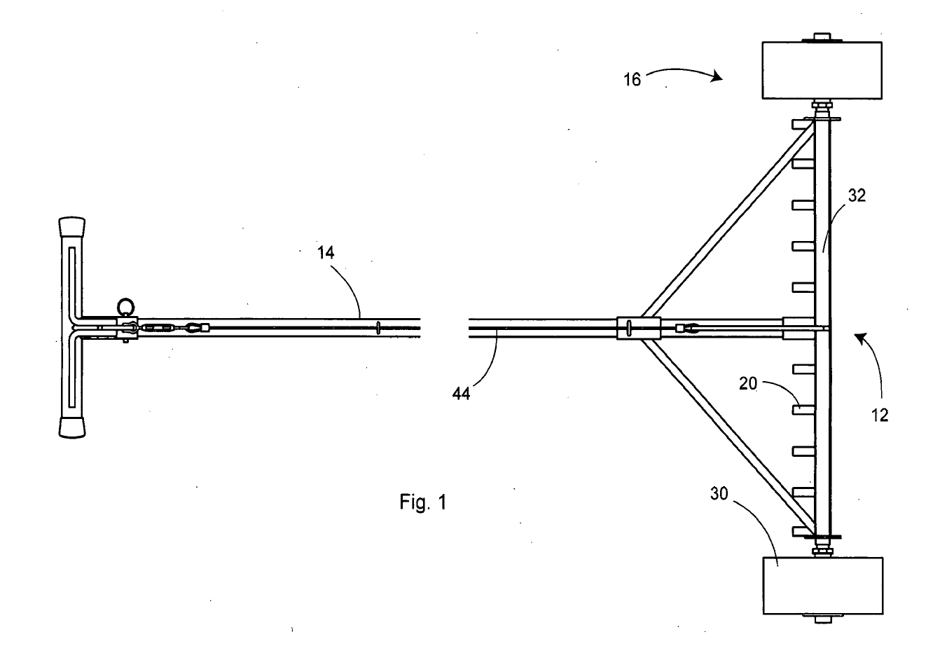

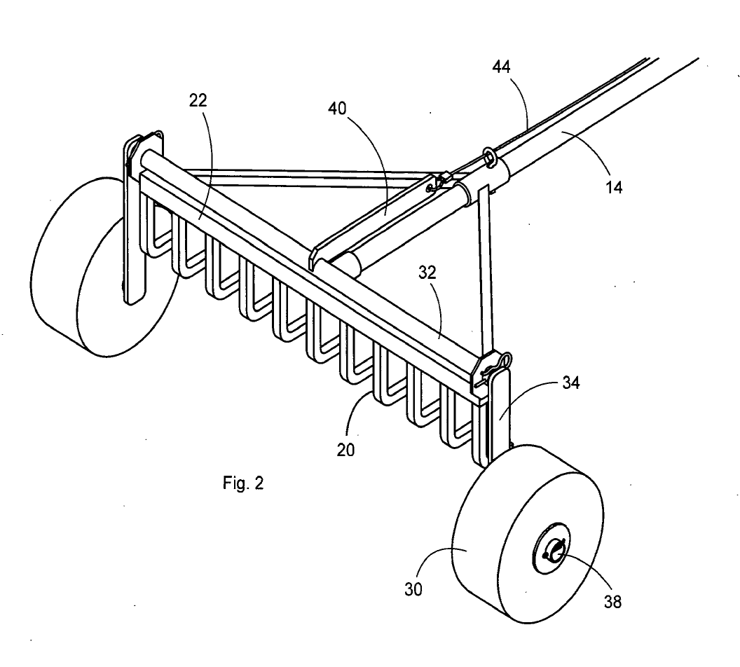

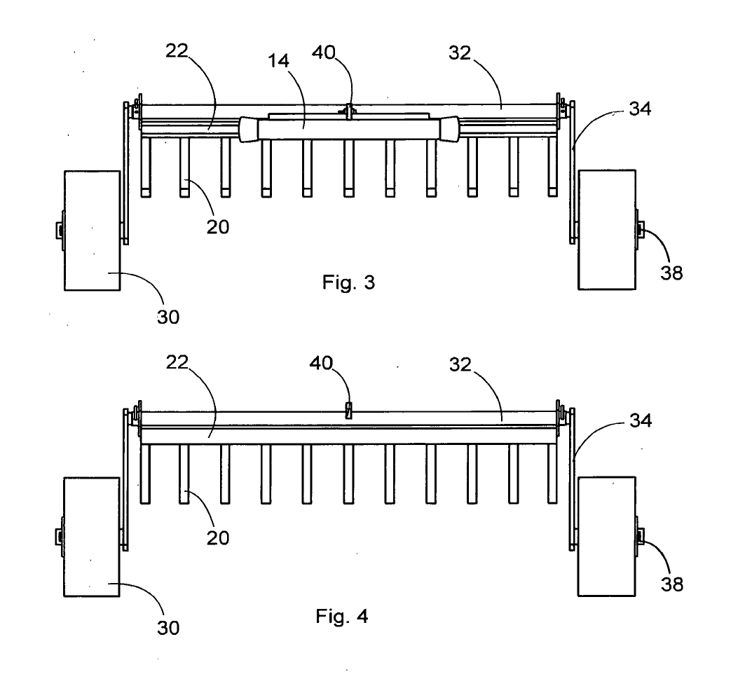

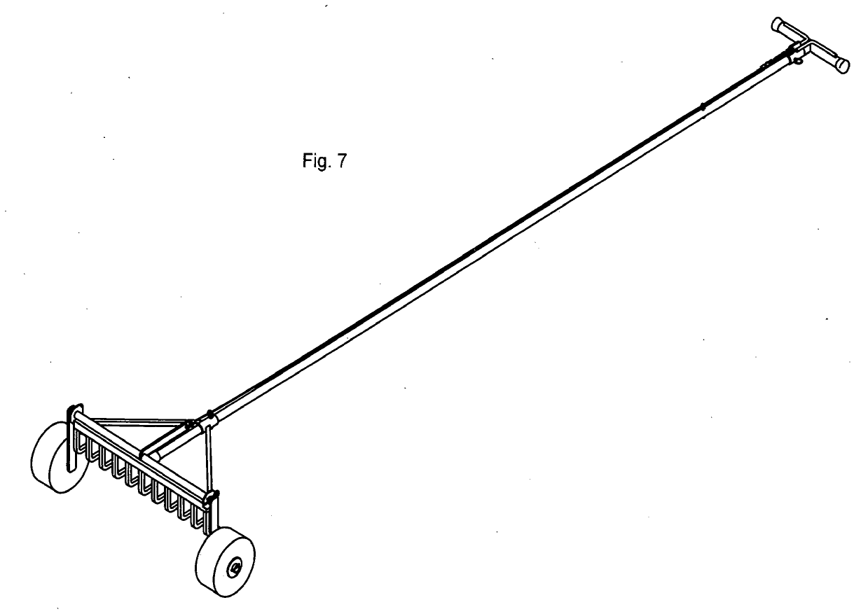

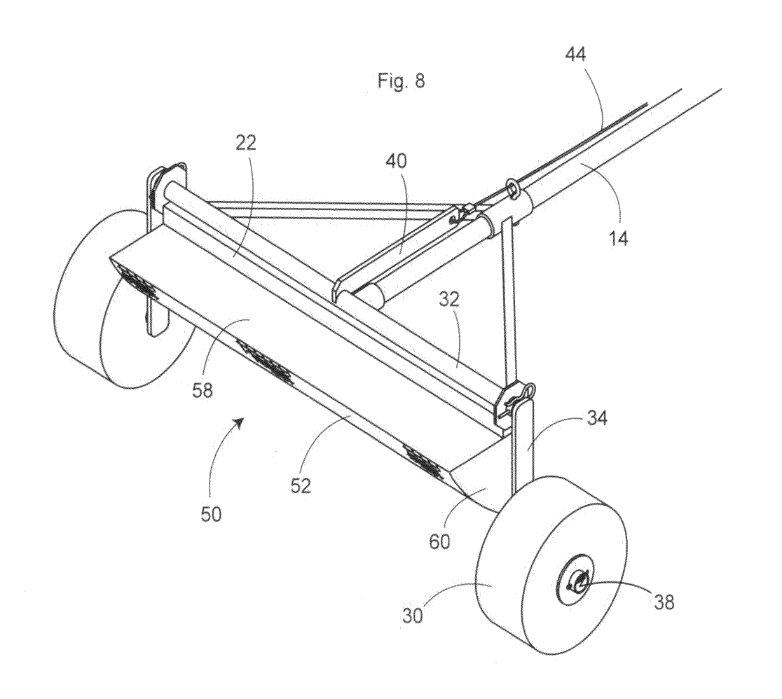

Debris collector 12, as illustrated in FIGS. 1-7 is comprised of a plurality of spaced, aligned tines 20 having upper ends attached to reinforcing bar 22. The lower segments of tines 20 curve rearwardly.

Flotation mechanism 16 is comprised of a rotatable shaft 32 having parallel connector arms 34 attached transversely to the proximal end to the ends of shaft 32, and axles 38 extending outwardly from the distal ends of arms 34 with floats 30 positioned at either side of debris collector 12 on axles 38. Connector arms 34 preferably extend slightly rearwardly from the vertical axis of debris collector 12.

Floats 30 are circular and are rotatably mounted on axles 38 so that rake 10 can be pulled or pushed along the ground or the surface of pond debris with debris collector 12 suspended above the ground or debris when floats 30 are in their lowered position. Floats 30 are moved from their lowered position to their raised position, allowing debris collector 12 to be lowered into the water, by an actuator comprised of control bar 40 which has a proximal end fixedly attached to rotatable shaft 32 and control cable 44 attached to the distal end of control bar 40 and extending to the proximal end of handle 14.

In operation, rake 10, with floats 30 in the lowered position illustrated in FIG. 5, is rolled from the pond edge and then over the top of the vegetation until debris collector 12 is beyond the vegetation to be removed. Floats 30 are then raised by releasing the tension of cable 44 so that debris collector 12 is lowered into the water as shown in FIG. 6. Rake 10 is then pulled toward shore collecting debris in collector 12.

FIG. 8 illustrates an alternative debris collector 50 comprised of a rectangular, curved open-mesh screen 52 having an upper edge attached to reinforcing bar 54. Cover 58 extends over the top of collector 50 and side plates 60 cover the sides of the collector; screen 52, cover 58 and plates 60 together creating a debris collection chamber.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A rake for removing debris from a body of water comprising:
a) a debris collector;
b) an elongated handle having a distal end attached to said debris collector, and a proximal end; and
c) a flotation mechanism having a lowered position and a raised position, said debris collector being held above a body of water when the flotation mechanism is in the lowered position and being lowered into the water when the flotation mechanism is in the raised position.

2. The rake of claim 1, wherein said flotation mechanism is rotatable between its raised and lowered positions.

3. The rake of claim 1, wherein said debris collector includes a horizontal reinforcing bar and a plurality of downwardly extending tines with proximal ends attached to said bar and distal ends.

4. The rake of claim 1, wherein said debris collector includes a horizontal reinforcing bar and a rectangular open mesh screen extending downwardly from said bar.

5. The rake of claim 1, wherein said handle has a transverse handgrip at its proximal end.

6. The rake of claim 1, wherein said flotation mechanism includes floats on either end of said debris collector.

7. A rake for removing debris from a body of water comprising:
a) a debris collector having opposed sides;
b) an elongated handle having a distal end attached to said debris collector, and a proximal end; and
c) a flotation mechanism having a raised position and a lowered position including
i) a rotatable shaft with opposed ends,
ii) parallel connector arms having proximal ends attached to the ends of said rotatable shaft and extending to one side of said shaft, and distal ends;
iii) floats attached to the distal ends of said connector arms; and
iv) an actuator to rotate said rotatable shaft to raise and lower said floats.

8. The rake of claim 7, wherein said flotation mechanism actuator is comprised of a control bar extending transversely from said rotatable shaft away from said connector arms, and a cable extending from said control bar to the proximal end of said handle.

9. The rake of claim 7, wherein said connectors arms include outwardly extending horizontal axles adjacent their distal ends, and said floats have a circular periphery and are rotatably mounted on said axles.

10. The rake of claim 7, wherein said connector arms are angled rearwardly from vertical when said flotation mechanism is in the lowered position.

11. The rake of claim 7, wherein said debris collector includes a horizontal reinforcing bar and a plurality of downwardly extending tines with proximal ends attached to said bar and distal ends.

12. The rake of claim 7, wherein said debris collector includes a horizontal reinforcing bar and a rectangular open mesh screen extending downwardly from said bar.

13. The rake of claim 7, wherein said handle has a transverse handgrip at its proximal end.

14. A rake for removing debris from a body of water comprising:
a) a debris collector having a horizontal reinforcing bar and opposed sides;
b) an elongated handle having a distal end attached to said debris collector reinforcing bar, and a proximal end; and
c) a flotation mechanism having a raised position and a lowered position including
i) a rotatable shaft with opposed ends,
ii) parallel connector arms having proximal ends attached to the ends of said rotatable shaft and extending to one side of said shaft, and distal ends having outwardly extending axles;
iii) floats having circular peripheries rotatably mounted on said axles; and
iv) an actuator to rotate said rotatable shaft to raise and lower said floats.

15. The rake of claim 14, wherein said flotation mechanism actuator is comprised of a control bar extending transversely from said rotatable shaft away from said connector arms, and a cable extending from said control bar to the proximal end of said handle.

16. The rake of claim 14, wherein said connector arms are angled rearwardly from vertical when said flotation mechanism is in the lowered position.

17. The rake of claim 14, wherein said debris collector includes a plurality of downwardly extending tines with proximal ends attached to said reinforcing bar and distal ends.

18. The rake of claim 17, wherein said tines are rearwardly curved.

19. The rake of claim 14, wherein said debris collector includes a rectangular open mesh screen extending downwardly from said bar.

20. The rake of claim 19, wherein said screen is rearwardly curved.
